(19) United States
(12) Patent Application Publication
(10) Pub. No.: US 2025/0149640 A1
(43) Pub. Date: May 8, 2025

(54) ALL-SOLID-STATE SECONDARY BATTERY

(71) Applicant: SAMSUNG SDI CO., LTD., Yongin-si (KR)

(72) Inventors: Yujin KANG, Yongin-si (KR); Jaehwan Ha, Yongin-si (KR); Dongho Koo, Yongin-si (KR); Juyun Kim, Yongin-si (KR)

(21) Appl. No.: 18/820,563

(22) Filed: Aug. 30, 2024

(30) Foreign Application Priority Data
Nov. 2, 2023 (KR) 10-2023-0150319
Nov. 21, 2023 (KR) 10-2023-0162448

(51) Int. Cl. H01M 10/0585; H01M 10/42; H01M 10/48; H01M 50/586; H01M 50/59

(52) U.S. Cl. CPC H01M 10/0585; H01M 10/4235; H01M 10/486; H01M 50/586; H01M 50/59

(57) ABSTRACT

An all-solid-state secondary battery includes a plurality of unit cells each including a stack of a negative electrode, a solid electrolyte layer, and a positive electrode; and a plurality of ceramic insulating layers, the plurality of ceramic insulating layers being between the negative electrodes of adjacent unit cells of the plurality of unit cells, and on the negative electrodes at outermost sides of the plurality of unit cells.

### CROSS-REFERENCE TO RELATED APPLICATION

This application claims priority to and the benefit of Korean Patent Application No. 10-2023-0150319 filed in the Korean Intellectual Property Office on Nov. 2, 2023, and Korean Patent Application No. 10-2023-0162448 filed in the Korean Intellectual Property Office on Nov. 21, 2023, the entire contents of which are incorporated herein by reference.

### BACKGROUND

### 1. Field

Embodiments relate to an all-solid-state secondary battery.

### 2. Description of the Related Art

Recently, in response to industrial demands, the development of batteries with high energy density and safety has been actively conducted. Lithium-ion batteries may be used not only in the fields of information-related devices and communication devices, but also in the field of automobiles. In the field of automobiles, safety is especially important because life is involved.

The above-described information disclosed in the technology that serves as the background of the present disclosure is only for improving understanding of the background of the present disclosure, and thus may include information that does not constitute the related art.

### SUMMARY

The embodiments may be realized by providing an all-solid-state secondary battery, including a plurality of unit cells each including a stack of a negative electrode, a solid electrolyte layer, and a positive electrode; and a plurality of ceramic insulating layers, the plurality of ceramic insulating layers being between the negative electrodes of adjacent unit cells of the plurality of unit cells, and on the negative electrodes at outermost sides of the plurality of unit cells.

Each unit cell of the plurality of unit cells may include a positive electrode current collector of the positive electrode in a middle, and a stack of a positive electrode active material layer of the positive electrode, the solid electrolyte layer, a negative electrode active material layer of the negative electrode, and a negative electrode current collector of the negative electrode sequentially on each of opposite surfaces of the positive electrode current collector.

The plurality of ceramic insulating layers may be on outer surfaces of each negative electrode current collector.

A first unit cell of the adjacent unit cells of the plurality of unit cells may include the positive electrode active material layer, the solid electrolyte layer, the negative electrode active material layer, and the negative electrode current collector sequentially stacked on each of opposite surfaces of the positive electrode current collector, a second unit cell of the adjacent unit cells of the plurality of unit cells is adjacent to the first unit cell may include the positive electrode active material layer, the solid electrolyte layer, he negative electrode active material layer, and the negative electrode current collector sequentially stacked on each of opposite surfaces of the positive electrode current collector, and ceramic insulating layers of the plurality of ceramic insulating layers may be between the first unit cell and the second unit cell and are in a single layer between a pair of the negative electrode current collectors.

The plurality of ceramic insulating layers may each include alumina or boehmite, and a binder.

The plurality of ceramic insulating layers may each include 5 to 10 wt % of a binder and 90 to 95 wt % of ceramic particles, based on a total weight of the ceramic insulating layer.

A thickness of each ceramic insulating layer of the plurality of ceramic insulating layers may be 5 μm to 50 μm.

Each unit cell of the plurality of unit cells may include a positive electrode active material layer, the solid electrolyte layer, a negative electrode active material layer forming the negative electrode, and a negative electrode current collector sequentially stacked on one surface of a positive electrode current collector forming the positive electrode.

A first unit cell of the adjacent unit cells of the plurality of unit cells may include the positive electrode active material layer, the solid electrolyte layer, the negative electrode active material layer, and the negative electrode current collector sequentially stacked on one surface of the positive electrode current collector, a second unit cell of the adjacent unit cells of the plurality of unit cells is adjacent to the first unit cell may include the positive electrode active material layer, the solid electrolyte layer, the negative electrode active material layer, and the negative electrode current collector sequentially stacked on one surface of the positive electrode current collector, and ceramic insulating layers of the plurality of ceramic insulating layers may be between the positive electrode current collector of the first unit cell and the negative electrode current collector of the second unit cell are in a single layer.

The embodiments may be realized by providing an all-solid-state secondary battery including a laminate including a stack of a negative electrode, a solid electrolyte layer, and a positive electrode; and a ceramic insulating layer on a side of the negative electrode that is opposite to the solid electrolyte layer and at an outermost side of the laminate, the ceramic insulating layer comprising a conductive material.

The laminate may include a positive electrode current collector of the positive electrode in a middle, and a stack of a positive electrode active material layer of the positive electrode, the solid electrolyte layer, a negative electrode active material of the negative electrode, and a negative electrode current collector of the negative electrode sequentially on each of opposite surfaces of the positive electrode current collector.

The ceramic insulating layer may include 30 to 95 wt % of a ceramic material, 0.1 to 30 wt % of a conductive material, and 1 to 40 wt % of a binder, based on a total weight of the ceramic insulating layer.

The ceramic insulating layer may include 80 to 90 wt % of a ceramic material, 5 to 10 wt % of a conductive material, and 5 to 10 wt % of a binder, based on a total weight of the ceramic insulating layer.

A temperature measurement portion of the laminate during a penetration test of a penetration pin may include a central portion where the penetration pin is inserted, and a peripheral portion at least 30 mm away from the penetration pin, and a temperature difference ratio between the central portion and the peripheral portion may be 9 to 39% if heat dissipation characteristics are compared based on a temperature difference ratio between the central portion and the peripheral portion.

The temperature difference ratio between the central portion and the peripheral portion may be 9 to 12%.

A maximum temperature ratio at the central portion may be 15 to 35%, compared with an all-solid-state secondary battery that does not include the ceramic insulating layer.

A maximum temperature ratio at the central portion may be 15 to 16%, compared with an all-solid-state secondary battery that does not include the ceramic insulating layer.

### BRIEF DESCRIPTION OF THE DRAWINGS

Features will be apparent to those of skill in the art by describing in detail exemplary embodiments with reference to the attached drawings in which:

FIG. 1 is a longitudinal cross-sectional view showing an all-solid-state secondary battery according to an embodiment.

FIG. 2 is a longitudinal cross-sectional view showing that a lithium metal layer is formed in the all-solid-state secondary battery according to the embodiment.

FIG. 3 is a longitudinal cross-sectional view showing an all-solid-state secondary battery according to a first embodiment.

FIG. 4 is a longitudinal cross-sectional view showing an all-solid-state secondary battery according to a second embodiment.

FIG. 5 is a graph showing a temperature relationship over time during nail penetration through an all-solid-state secondary battery.

FIG. 6 is a graph showing a voltage relationship over time during nail penetration through an all-solid-state secondary battery.

FIG. 7 is a longitudinal cross-sectional view showing an all-solid-state secondary battery according to a third embodiment.

FIG. 8 is a plan view showing a position of a laminate where a penetration pin penetrates during a penetration test in Experimental Examples 11 to 14 and Comparative Example 2.

FIG. 9 is a graph showing temperature changes over time at a central portion where the penetration pin penetrates and a peripheral portion in Experimental Examples 11 and 12 during a test of FIG. 7.

### DETAILED DESCRIPTION OF THE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. Like reference numerals refer to like elements throughout.

In addition, unless explicitly described to the contrary, the word “comprise”, and variations such as “include,” “includes,” “including,” “comprises,” or “comprising”, will be understood to imply the inclusion of stated elements but not the exclusion of any other elements.

In the drawings, the thickness of layers, films, panels, regions, etc., may be exaggerated for clarity, and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface. Here, “or” is not to be construed as an exclusive meaning, and for example, “A or B” is construed to include A, B, A+B, and the like.

### Positive Electrode for All-Solid-State Secondary Battery

An embodiment provides a positive electrode for an all-solid-state secondary battery including a current collector and a positive electrode active material layer on the current collector. In an implementation, the positive electrode active material layer may include a positive electrode active material, a sulfide solid electrolyte, a binder, or a conductive material. In an implementation, a positive electrode for the all-solid-state secondary battery may include more or fewer components than the components described above.

In an implementation, a positive electrode for the all-solid-state secondary battery may be manufactured by applying a positive electrode composition including a positive electrode active material, a sulfide solid electrolyte, a binder, and a conductive material to a current collector, followed by drying and rolling.

### Positive Electrode Active Material

The positive electrode active material may be a suitable material for all-solid-state secondary batteries. In an implementation, the positive electrode active material may be a compound capable of reversible intercalation and deintercalation of lithium and may include a compound represented by any one of the following chemical formulas.

LiₐA_{1-b}X_{b}D′₂(0.90≤a≤1.8,0≤b≤0.5);

LiₐA_{1-b}X_{b}O_{2-c}D′_{c}(0.90≤a≤1.8,0≤b≤0.5,0≤c≤0.05);

LiₐE_{1-b}X_{b}O_{2-c}D′_{c}(0.90≤a≤1.8,0≤b≤0.5,0≤c≤0.05);

LiₐE_{2-b}X_{b}O_{4-c}D′_{c}(0.90≤a≤1.8, 0≤b≤0≤c≤0.05);

LiₐNi_{1-b-c}Co_{b}X_{c}D′_{α}(0.90≤a≤1.8, 0≤b≤0.5,0≤c≤0.5, 0<α≤2);

LiₐNi_{1-b-c}Co_{b}X_{c}O_{2-α}T_{α}(0.90≤a≤1.8, 0≤b≤0.5,0c c≤0.05,0<α<2);

LiₐNi_{1-b-c}Co_{b}X_{c}O_{2-α}T₂(0.90≤a≤1.8, 0≤b≤0.5, 0≤c≤0.05, 0<α<2);

LiₐNi_{1-b-c}Mn_{b}X_{c}D′α(0.90≤a≤1.8, 0≤b≤0.5, 0≤c≤0.05, 0<α≤2);

LiₐNi_{1-b-c}Mn_{b}X_{c}O_{2-α}T_{α}(0.90≤a≤1.8, 0≤b≤0.5, 0≤e0.0, 0≤a≤2);

LiₐNi_{1-b-c}Mn_{b}X_{c}O_{2-α}T₂(0.90≤a≤1.8, 0≤b≤0.5,0 5≤0.05,0≤a≤2);

LiₐNi_{b}E_{c}G_{d}O₂(0.90≤a≤1.8, 0≤b≤0.9, 0<e<0.5, 0.001≤d≤0.1);

LiₐNi_{b}Co_{c}Mn_{d}GₑO₂(0.90≤a≤1.8, 0≤b≤0.9, 0≤c≤0.5, 0≤d≤0.5, 0.001≤e≤0.1);

LiₐNiG_{b}O₂(0.90≤a≤1.8, 0.001≤b≤0.1);

LiₐCoG_{b}O₂(0.90≤a≤1.8, 0.001≤b≤0.1);

LiₐMn_{1-b}G_{b}O₂(0.90≤a≤1.8, 0.001≤b≤0.1);

LiₐMn₂G_{b}O₄(0.90≤a≤1.8, 0.001≤b≤0.1);

LiₐMn_{1-g}G_{g}PO₄(0.90≤a≤1.8, 0<g<0.5);

QO₂; QS₂; LiQS₂;

V₂O₅; LiV₂O₅;

LiZO₂;

LiNiVO₄;

Li_{(3-f)}J₂PO₄₃(0≤f≤2);

Li_{(3-f)}Fe₂PO₄₃(0≤f≤2);

LiₐFePO₄(0.90≤a≤1.8).

In the above Chemical Formulas, A may be Ni, Co, Mn, or a combination thereof, X may be Al, Ni, Co, Mn, Cr, Fe, Mg, Sr, V, rare earth elements, or a combination thereof, D′ may be O, F, S, P, or a combination thereof, E may be Co, Mn, or a combination thereof, T may be F, S, P, or a combination thereof, G may be Al, Cr, Mn, Fe, Mg, La, Ce, Sr, V, or a combination thereof; Q may be Ti, Mo, Mn, or a combination thereof; Z may be Cr, V, Fe, Sc, Y, or a combination thereof; and J may be V, Cr, Mn, Co, Ni, Cu, or a combination thereof.

The positive electrode active material may include, e.g., lithium cobalt oxide (LCO), lithium nickel oxide (LNO), lithium nickel cobalt oxide (NC), lithium nickel cobalt aluminum oxide (NCA), lithium nickel cobalt manganese oxide (NCM), and lithium nickel manganese oxide (NM), lithium manganese oxide (LMO), or lithium ferrous phosphate oxide (LFP).

The positive electrode active material may include a lithium nickel oxide represented by Chemical Formula 1 below, a lithium cobalt oxide represented by Chemical Formula 2 below, a lithium ferrous phosphate compound represented by Chemical Formula 3 below, or a combination thereof.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1≤0.7, and M¹ and M² may be Al, B, Ba, Ca, Ce, Co, Cr, Cu, F, Fe, Mg, Mn, Mo, Nb, P, S, Si, Sr, Ti, V, W, or Zr.

Liₐ₂COₓ₂M³₁₋ₓ₂O₂ [Chemical Formula 2]

In Chemical Formula 2, 0.9≤a2≤1.8, 0.6≤x2≤1, and M³ may be Al, B, Ba, Ca, Ce, Cr, Cu, F, Fe, Mg, Mn, Mo, Nb, P, S, Si, Sr, Ti, V, W, or Zr.

Liₐ₃Feₓ₃M⁴₁₋ₓ₃PO₄ [Chemical Formula 3]

In Chemical Formula 3, 0.9≤a3≤1.8, 0.6≤x3≤1, and M⁴ may be Al, B, Ba, Ca, Ce, Co, Cr, Cu, F, Fe, Mg, Mn, Mo, Nb, P, S, Si, Sr, Ti, V, W, or Zr.

An average particle diameter (D50) of the positive electrode active material may be 1 μm to 25 μm, e.g., 3 μm to 25 μm, 5 μm to 25 μm, 5 μm to 20 μm, 8 μm to 20 μm, or 10 μm to 18 μm. The positive electrode active material within these particle diameter ranges may be harmoniously mixed with other components in the positive electrode active material layer and may implement the high capacity and high energy density.

The positive electrode active material may be in the form of a secondary particle made by agglomeration of a plurality of primary particles, or may be in the form of a single particle. In an implementation, the positive electrode active material may be spherical or close to a spherical shape, or may be polyhedral or amorphous.

### Sulfide-Solid Electrolyte

The sulfide-based solid electrolyte may include, e.g., Li₂S—P₂S₅, Li₂S—P₂S₅—LiX (X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer, and Z is Ge, Zn, or Ga), Li₂S—GeS₂, Li₂S—SiS₂—Li₃PO₄, Li₂S—SiS₂—LiₚMO_{q} (p and q are integers, and M is P, Si, Ge, B, Al, Ga, or In), or a combination thereof.

The sulfide solid electrolyte may be obtained by, e.g., mixing Li₂S and P₂S₅ at a molar ratio of 50:50 to 90:10 or 50:50 to 80:20 and optionally heat treating the mixture. Within the above mixing ratio ranges, a sulfide solid electrolyte having excellent ionic conductivity may be manufactured. In an implementation, SiS₂, GeS₂, B₂S₃ and the like as other components may be further included to further improve the ionic conductivity.

A mechanical milling or solution method may be applied as a method of mixing sulfur-containing raw materials for producing a sulfide solid electrolyte. The mechanical milling is a method of making starting materials into particulates and mixing the same by putting the starting materials, ball mills, or the like in a reactor and intensely stirring them. In the solution method, starting materials may be mixed in a solvent to obtain a solid electrolyte as a precipitate. In an implementation, a heat treatment may be performed after mixing, crystals of the solid electrolyte may become more rigid, and ionic conductivity may be improved. In an implementation, the sulfide solid electrolyte can be manufactured by mixing sulfur-containing raw materials and heat-treating them two or more times. In an implementation, a sulfide solid electrolyte with high ionic conductivity and rigidity can be manufactured.

In an implementation, the sulfide solid electrolyte particles may include an argyrodite-type sulfide. The argyrodite-type sulfide can be represented by, e.g., LiₐM_{b}P_{c}S_{d}Aₑ (a, b, c, d, and e are all 0 or greater and 12 or less, M is metal excluding Li or a combination of a plurality of metals excluding Li, and A is F, Cl, Br, or I), or Li₇₋ₓPS₆₋ₓAₓ (x is 0.2 or greater and 1.8 or less, and A is F, Cl, Br, or I). The argyrodite-type sulfide may be, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or the like.

A sulfide solid electrolyte particle containing such argyrodite-type sulfide may have high ionic conductivity close to about 10⁻⁴ to about 10⁻² S/cm, which is ionic conductivity of a general liquid electrolyte, at room temperature, and thus, can form a close bond between the positive electrode active material and the solid electrolyte, and further, a close interface between the electrode layer and the solid electrolyte layer without deteriorating the ionic conductivity. An all-solid-state battery including the same may exhibit improved battery performance such as rate characteristics, coulombic efficiency, and life characteristics.

The argyrodite-type sulfide solid electrolyte can be manufactured by, e.g., mixing lithium sulfide, phosphorus sulfide, and optionally lithium halide. After mixing them, heat treatment may be performed. The heat treatment may include, e.g., two or more heat treatment steps.

An average particle diameter (D50) of the sulfide solid electrolyte particle according to an embodiment may be 5.0 μm or less, e.g., 0.1 μm to 5.0 μm, 0.1 μm to 4.0 m, 0.1 μm to 3.0 μm, 0.5 μm to 2.0 μm, or 0.1 μm to 1.5 μm. In an implementation, the sulfide solid electrolyte particle may be a small particle having an average particle diameter (D50) of 0.1 μm to 1.0 μm or a large particle having an average particle diameter (D50) of 1.5 μm to 5.0 μm, depending on the location or purpose of use. The sulfide solid electrolyte particle within these particle diameter ranges can effectively penetrate between solid particles in the battery, and may have an excellent contact property with the electrode active material and connectivity between the solid electrolyte particles. The average particle diameter of the sulfide solid electrolyte particle may be measured using a microscope image. In an implementation, a particle size distribution may be obtained by measuring sizes of about 20 particles in a scanning electron microscope image, and D50 may be calculated from the particle size distribution.

The content of the solid electrolyte in the positive electrode for an all-solid-state battery may be 0.5 wt % to 35 wt %, e.g., 1 wt % to 35 wt %, 5 wt % to 30 wt %, 8 wt % to 25 wt %, or 10 wt % to 20 wt %. This is a content with respect to a total weight of components in the positive electrode, e.g., may be a content with respect to a total weight of the positive electrode active material layer.

In an implementation, the positive electrode active material layer may include 50 wt % to 99.35 wt % of the positive electrode active material, 0.5 wt % to 35 wt % of the sulfide solid electrolyte, 0.1 wt % to 10 wt % of the fluorine resin binder, and 0.05 wt % to 5 wt % of the vanadium oxide, with respect to 100 wt % of the positive electrode active material layer. Within these content ranges, the positive electrode for an all-solid-state secondary battery may maintain high adhesive force and also may maintain the viscosity of the positive electrode composition at an appropriate level while implementing high capacity and high ionic conductivity, thereby improving processability.

### Binder

The binder may adhere positive electrode active material particles to each other and to a current collector. Representative examples may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

### Conductive Material

The positive electrode active material layer may further include a conductive material. The conductive material may provide conductivity to an electrode, and may include, e.g., a carbon material such as natural graphite, artificial graphite, carbon black, acetylene black, Ketjen black, a carbon fiber, and a carbon nanotube; a metal material in the form of metal powder or metal fiber containing copper, nickel, aluminum, silver, and the like; a conductive polymer such as a polyphenylene derivative; or a combination thereof.

The conductive material may be included in an amount of 0.1 wt % to 5 wt %, or 0.1 wt % to 3 wt % with respect to a total weight of each component of the positive electrode for the all-solid-state battery, or with respect to a total weight of the positive electrode active material layer. Within the above content ranges, the conductive material can improve electrical conductivity without deteriorating battery performance.

In an implementation, the positive electrode active material layer may further include the conductive material, and the positive electrode active material layer may include 45 wt % to 99.25 wt % of the positive electrode active material, 0.5 wt % to 35 wt % of the sulfide solid electrolyte, 0.1 wt % to 10 wt % of the fluorine resin binder, 0.05 wt % to 5 wt % of the vanadium oxide, and 0.1 wt % to 5 wt % of the conductive material with respect to 100 wt % of the positive electrode active material layer.

In an implementation, the positive electrode for a lithium secondary battery may further include an oxide inorganic solid electrolyte, in addition to the solid electrolyte described above. The oxide inorganic solid electrolyte may include, e.g., Li₁₊ₓTi₂₋ₓAl(PO₄)₃(LTAP)(0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT)(0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, garnet ceramics Li₃₊ₓ, La₃M₂O₁₂ (M═Te, Nb, or Zr; x is an integer from 1 to 10), or a combination thereof.

### All-Solid-State Secondary Battery

An embodiment provides an all-solid-state secondary battery including the positive electrode described above, a negative electrode, and a solid electrolyte layer between the positive electrode and the negative electrode. The all-solid-state secondary battery may also be expressed as an all-solid-state battery or an all-solid-state lithium secondary battery.

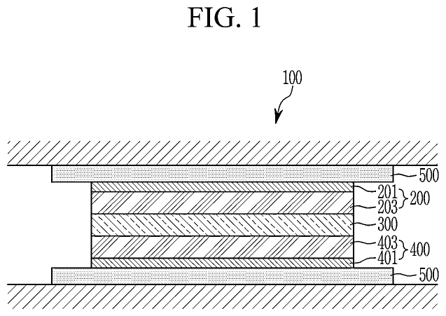

FIG. 1 is a cross-sectional view of an all-solid-state secondary battery according to an embodiment. Referring to FIG. 1, an all-solid-state secondary battery 100 may have such a structure that an electrode assembly in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked is stored in a case such as a pouch. The all-solid-state secondary battery 100 may further include an elastic layer 500 on an outer side of at least one of the positive electrode 200 and the negative electrode 400. In an implementation, as shown in FIG. 1, one electrode assembly may include the negative electrode 400, the solid electrolyte layer 300, and the positive electrode 200, or an all-solid-state battery can be manufactured by stacking two or more electrode assemblies.

### Negative Electrode

The negative electrode for an all-solid-state battery may include, e.g., a current collector and a negative electrode active material layer on the current collector. The negative electrode active material layer may include a negative electrode active material and may further include a binder, a conductive material, or a solid electrolyte.

The negative electrode active material may include a material capable of reversibly intercalation/deintercalating lithium ions, lithium metal, an alloy of lithium metal, a material capable of being doped and undoped on lithium, or a transition metal oxide.

The material capable of reversibly intercalating/deintercalating lithium ions may be a carbon negative electrode active material, e.g., crystalline carbon, amorphous carbon, or a combination thereof. Examples of the crystalline carbon may include graphite such as amorphous, plate-like, flake-like, spherical or fibrous natural graphite or artificial graphite, and examples of the amorphous carbon may include soft carbon or hard carbon, mesophase pitch carbide, fired coke, and the like.

For the alloy of the lithium metal, an alloy of lithium and a metal, e.g., Na, K, Rb, Cs, Fr, Be, Mg, Ca, Sr, Si, Sb, Pb, In, Zn, Ba, Ra, Ge, Al, or Sₙ, may be used.

For the material capable of being doped or undoped on the lithium, a Si negative electrode active material or an Sₙ negative electrode active material may be used. Examples of the Si negative electrode active material may include silicon, silicon-carbon composite, SiOₓ (0<x≤2), and a Si-Q alloy (Q is an element selected from the group consisting of alkali metals, alkali earth metals, Group 13 elements, Group 14 elements, Group 15 elements, Group 16 elements, transition metals, rare-earth elements, and combinations thereof, but is not Si). Examples of the Sₙ negative electrode active material may include Sₙ, SnO₂, a Sₙ—R alloy (R is an element selected from the group consisting of alkali metals, alkali earth metals, Group 13 elements, Group 14 elements, Group 15 elements, Group 16 elements, transition metals, rare-earth elements, and combinations thereof, but is not Sₙ). In addition, a mixture of at least one thereof and SiO₂ may be used. The elements Q and R may independently be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sₙ, In, Tl, Ge, P, As, Sb, Bi, S, Se, Te, Po, or a combination thereof.

The silicon-carbon composite may be, e.g., a silicon-carbon composite including a core including crystalline carbon and a silicon particle and an amorphous carbon coating layer positioned on a surface of the core. The crystalline carbon may be artificial graphite, natural graphite, or a combination thereof. As the amorphous carbon precursor, coal pitch, mesophase pitch, petroleum pitch, coal oil, petroleum heavy oil, or polymer resin such as phenol resin, furan resin, and polyimide resin can be used. In an implementation, a content of silicon may be 10 wt % to 50 wt % with respect to a total weight of the silicon-carbon composite. In an implementation, a content of the crystalline carbon may be 10 wt % to 70 wt % with respect to the total weight of the silicon-carbon composite, and a content of the amorphous carbon may be 20 wt % to 40 wt % with respect to the total weight of the silicon-carbon composite. In an implementation, a thickness of the amorphous carbon coating layer may be 5 nm to 100 nm.

An average particle diameter (D50) of the silicon particle may be 10 nm to 20 μm, e.g., 10 nm to 500 nm. The silicon particle may be present in an oxidized form, and in this case, an atomic content ratio of Si:O in the silicon particle, which indicates a degree of oxidation, may be 99:1 to 33:67. The silicon particle may be a SiO, particle, in which case a range of x in SiOx may be greater than 0 and less than 2. Here, the average particle diameter (D50) is measured with a particle size analyzer using a laser diffraction method and refers to a diameter of a particle with a cumulative volume of 50% by volume in the particle size distribution.

The Si negative electrode active material or Sₙ negative electrode active material may be used by mixing with a carbon negative electrode active material. A mixing ratio of the Si negative electrode active material or Sₙ negative electrode active material and the carbon negative electrode active material may be a weight ratio of 1:99 to 90:10.

A content of the negative electrode active material in the negative electrode active material layer may be 95 wt % to 99 wt % with respect to the total weight of the negative electrode active material layer.

In an implementation, the negative electrode active material layer may further include a binder. In an implementation, the negative electrode active material layer may further include conductive material. A content of the binder in the negative electrode active material layer may be 1 wt % to 5 wt % with respect to the total weight of the negative electrode active material layer. In an implementation, a conductive material may be further included, and the negative electrode active material layer may include 90 wt % to 98 wt % of the negative electrode active material, 1 wt % to 5 wt % of the binder, and 1 wt % to 5 wt % of the conductive material.

The binder may adhere the negative electrode active material particles to each other well and also to adhere the negative electrode active material to the current collector well. The binder may include a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

Examples of the water-soluble binder may include a rubber binder or a polymer resin binder. The rubber binder may include a styrene-butadiene rubber, an acrylated styrene-butadiene rubber, an acrylonitrile-butadiene rubber, an acrylic rubber, a butyl rubber, a fluoro rubber, or a combination thereof. The polymer resin binder may include polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

In an implementation, a water-soluble binder may be used as the negative electrode binder, and a thickener capable of imparting viscosity may be used together. In an implementation, the thickener may include, e.g., a cellulose compound. The cellulose compound may include carboxymethyl cellulose, hydroxypropylmethyl cellulose, methyl cellulose, alkali metal salts thereof, or a combination thereof. As the alkali metal, Na, K, or Li may be used. An amount of the thickener used may be 0.1 to 3 parts by weight with respect to 100 parts by weight of the negative electrode active material.

The conductive material may provide conductivity to an electrode, and may include, e.g., a carbon material such as natural graphite, artificial graphite, carbon black, acetylene black, Ketjen black, a carbon fiber, and a carbon nanotube; a metal material in the form of metal powder or metal fiber including copper, nickel, aluminum, silver, and the like; a conductive polymer such as a polyphenylene derivative; or a mixture thereof.

The negative electrode current collector may include a copper foil, a nickel foil, a stainless steel foil, a titanium foil, a nickel foam, a copper foam, a polymer substrate coated with a conductive metal, or a combination thereof.

In an implementation, the negative electrode for an all-solid-state battery may be a precipitation-type negative electrode. The precipitation-type negative electrode refers to a negative electrode which does not include a negative electrode active material during assembling of a battery but in which lithium metal or the like is precipitated during charging of the battery and serves as a negative electrode active material.

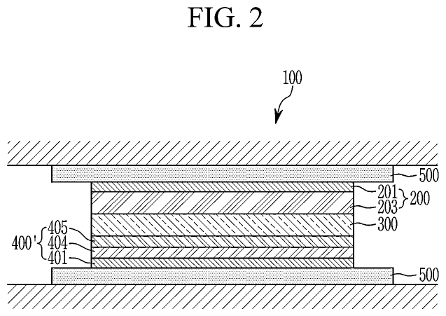

FIG. 2 is a schematic cross-sectional view of an all-solid-state secondary battery including a precipitation-type negative electrode according to an embodiment. Referring to FIG. 2, the precipitation-type negative electrode 400′ may include a negative electrode current collector 401 and a negative electrode coating layer 405 on the current collector. In an all-solid-state battery having the precipitation-type negative electrode 400′, initial charging may begin in the absence of a negative electrode active material, and during the charging, lithium metal with a high density or the like may be precipitated between the negative electrode current collector 401 and the negative electrode coating layer 405 and may form a lithium metal layer 404, which can serve as a negative electrode active material. Accordingly, in an all-solid-state battery that has been charged one or more times, the precipitation-type negative electrode 400′ may include the negative electrode current collector 401, the lithium metal layer 404 on the current collector, and the negative electrode coating layer 405 on the metal layer. The lithium metal layer 404 refers to a layer of lithium metal or the like precipitated during the charging process of the battery and may be called a metal layer or a negative electrode active material layer.

The negative electrode coating layer 405 may include metal, a carbon material, or a combination thereof that serves as a catalyst.

The metal may include, e.g., gold, platinum, palladium, silicon, silver, aluminum, bismuth, tin, zinc, or a combination thereof, and may be composed of one selected therefrom or an alloy of more than one thereof. In an implementation, the metal may be present in the form of a particle, and an average particle diameter (D50) thereof may be about 4 μm or less, e.g., 10 nm to 4 km.

The carbon material may be, e.g., crystalline carbon, amorphous carbon, or a combination thereof. The crystalline carbon may be, e.g., natural graphite, artificial graphite, a mesophase carbon microbead, or a combination thereof. The amorphous carbon may be, e.g., carbon black, activated carbon, acetylene black, Denka black, Ketjen black, or a combination thereof.

In an implementation, the negative electrode coating layer 405 may include both the metal and the carbon material, and a mixing ratio of the metal and the carbon material may be, e.g., a weight ratio of 1:10 to 2:1. In this case, the precipitation of lithium metal can be effectively promoted and the characteristics of the all-solid-state battery can be improved. The negative electrode coating layer 405 may include, e.g., a carbon material on which catalyst metal is supported, or a mixture of metal particles and carbon material particles.

The negative electrode coating layer 405 may include, e.g., the metal and amorphous carbon, and in this case, the precipitation of lithium metal can be effectively promoted.

The negative electrode coating layer 405 may further include a binder, and the binder may be a conductive binder. In an implementation, the negative electrode coating layer 405 may further include an additive, e.g., a filler, a dispersant, or an ion conductive material.

A thickness of the negative electrode coating layer 405 may be, e.g., 100 nm to μm, 500 nm to 10 μm, or 1 μm to 5 μm.

In an implementation, the precipitation-type negative electrode 400′ may further include a thin film on the surface of the current collector, e.g., between the current collector and the negative electrode coating layer. The thin film may contain an element that can form an alloy with lithium. The element that can form an alloy with lithium may be, e.g., gold, silver, zinc, tin, indium, silicon, aluminum, bismuth, or the like, which may be used alone or as an alloy of more than one thereof. The thin film can further planarize a precipitation shape of the lithium metal layer 404 and further improve the characteristics of the all-solid-state battery. The thin film may be formed by, e.g., a vacuum deposition method, a sputtering method, a plating method, or the like. The thin film may have a thickness of, e.g., 1 nm to 500 nm.

### Solid Electrolyte Layer

The solid electrolyte layer 300 may include a sulfide solid electrolyte, an oxide solid electrolyte, or the like. The sulfide solid electrolyte and the oxide solid electrolyte may be the same as described above.

In an implementation, the solid electrolyte included in the positive electrode 200 and the solid electrolyte included in the solid electrolyte layer 300 may include the same compound or different compounds. In an implementation, both the positive electrode 200 and the solid electrolyte layer 300 may include an argyrodite-type sulfide-based solid electrolyte, and the overall performance of the all-solid-state secondary battery may be improved. In an implementation, both the positive electrode 200 and the solid electrolyte layer 300 may include the coated solid electrolyte described above, and the all-solid-state secondary battery can implement excellent initial efficiency and life characteristics while implementing a high capacity and a high energy density.

In an implementation, an average particle diameter (D50) of the solid electrolyte layer included in the positive electrode 200 may be smaller than an average particle diameter (D50) of the solid electrolyte included in the solid electrolyte layer 300. In this case, the overall performance can be improved by maximizing the energy density of the all-solid-state battery and increasing the mobility of lithium ions. In an implementation, the average particle diameter (D50) of the solid electrolyte included in the positive electrode 200 may be 0.1 μm to 1.0 μm, or 0.1 μm to 0.8 μm, and the average particle diameter (D50) of the solid electrolyte included in the solid electrolyte layer 300 may be 1.5 μm to 5.0 μm, 2.0 μm to 4.0 μm, or 2.5 μm to 3.5 μm. Within the above particle diameter ranges, the energy density of the all-solid-state secondary battery may be maximized and the transfer of lithium ions may be facilitated, making it possible to suppress resistance and thus to improve the overall performance of the all-solid-state secondary battery. Here, the average particle diameter (D50) of the solid electrolyte may be measured with a particle size analyzer using a laser diffraction method. Alternatively, a particle size distribution may be obtained by measuring sizes of about 20 particles selected from a microscope image such as a scanning electron microscope, and a D50 value may be calculated from the particle size distribution.

The solid electrolyte layer may further include a binder, in addition to the solid electrolyte. In an implementation, the binder may include a styrene butadiene rubber, polytetrafluoroethylene, polyvinylidene fluoride, polyethylene, an acrylate polymer, or a combination thereof, or other suitable binder. The acrylate polymer may be, e.g., butyl acrylate, polyacrylate, polymethacrylate, or a combination thereof.

The solid electrolyte layer may be formed by adding a solid electrolyte to a binder solution, coating a base film with the solution, and drying the resultant. A solvent for the binder solution may be isobutyl isobutyrate, xylene, toluene, benzene, hexane, or a combination thereof.

A thickness of the solid electrolyte layer may be, e.g., 10 μm to 150 km.

The solid electrolyte layer may further include an alkali metal salt, an ionic liquid, or a conductive polymer.

The alkali metal salt may be, e.g., a lithium salt. A concentration of the lithium salt in the solid electrolyte layer may be 1 M or more, e.g., 1 M to 4 M. In this case, the lithium salt can improve ionic conductivity by improving lithium ion mobility in the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato) borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In an implementation, the lithium salt may be an imide salt. In an implementation, the imide lithium salt may include lithium bis(trifluoro methanesulfonyl)imide (LiTFSI, LiN(SO₂CF₃)₂), or lithium bis(fluorosulfonyl)imide (LiFSI, LiN(SO₂F)₂). The lithium salt can maintain or improve ionic conductivity by appropriately maintaining chemical reactivity with an ionic liquid.

The ionic liquid refers to a salt or a room temperature molten salt that has a melting point equal to or lower than a room temperature, is in a liquid state at room temperature and is composed of only ions.

The ionic liquid may be a compound including a cation, e.g., ammonium, pyrrolidinium, pyridinium, pyrimidinium, imidazolium, piperidinium, pyrazolium, oxazolium, pyridazinium, phosphonium, sulfonium, or triazolium cations, or a mixture thereof, and an anion, e.g., BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)2N—, (C₂F₅SO₂)(CF₃SO₂)N—, or (CF₃SO₂)₂N—

The ionic liquid may be, e.g., N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

A weight ratio of the solid electrolyte and the ionic liquid in the solid electrolyte layer may be 0.1:99.9 to 90:10, e.g., 10:90 to 90:10, 20:80 to 90:10, 30:70 to 90:10, 40:60 to 90:10, or 50:50 to 90:10. The solid electrolyte layer that satisfies the above ranges can maintain or improve ionic conductivity by improving an electrochemical contact area with the electrode. Accordingly, the energy density, discharge capacity, rate characteristics, or the like of the all-solid-state battery can be improved.

The all-solid-state battery may be a unit battery having a structure of a positive electrode/a solid electrolyte layer/a negative electrode, a bicell having a structure of a positive electrode/a solid electrolyte layer/a negative electrode/a solid electrolyte layer/a positive electrode, or a stacked battery in which the structure of the unit cell is repeated.

A shape of the all-solid-state battery may be a suitable shape, a coin type, a button type, a sheet type, a stack type, a cylindrical shape, a flat type, or the like. In an implementation, the all-solid-state battery may be applied to large-sized batteries used in electric vehicles, or the like. In an implementation, the all-solid-state battery may also be used in a hybrid vehicle such as a plug-in hybrid electric vehicle (PHEV). In an implementation, it can be used in fields that require a large amount of power storage, and for example, can also be used to an electric bicycle, an electric tool or the like.

An embodiment may include an all-solid-state secondary battery using a sulfide solid electrolyte. The solid electrolyte cannot be used while exposed to the atmosphere due to its nature, and the solid electrolyte needs to be blocked or isolated from the atmosphere. In an implementation, the all-solid-state secondary battery may be manufactured by inserting it into an exterior body using a laminated film or a rigid material.

A negative electrode, a solid electrolyte layer, a positive electrode, and an elastic sheet may be stacked on the laminated film, and the alignment of the stacked elastic sheet could be misaligned during a vacuum process upon sealing. Additionally, it could be difficult to provide uniform pressure to the negative electrode/solid electrolyte layer/positive electrode due to the presence of bubbles during stacking.

If the all-solid-state secondary battery were not uniformly pressurized from the outside during discharging, a migration speed of lithium ions could decrease, lowering discharge efficiency. If the battery were to be locally pressurized, lithium ions could move to the pressurized region, lowering discharge efficiency.

An embodiment makes it possible to increase coulombic efficiency, even if the thickness of the negative electrode were to vary due to charging and discharging. To this end, an embodiment may be configured to eliminate generation of air bubbles between the laminate of the negative electrode, solid electrolyte layer, and positive electrode and the elastic sheet. Additionally, an embodiment may be configured to eliminate generation of air bubbles between unit cells when stacking a plurality of unit cells.

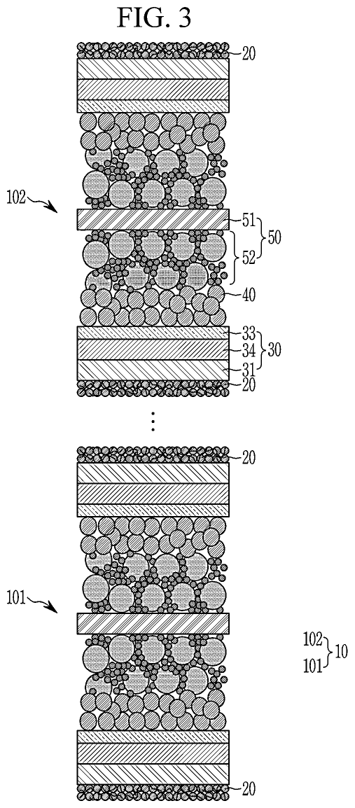

FIG. 3 is a longitudinal cross-sectional view showing an all-solid-state secondary battery according to a first embodiment. Referring to FIG. 3, the all-solid-state secondary battery of the first embodiment may include unit cells 10 and ceramic insulating layers 20. The unit cells 10 may each include a stack of a negative electrode 30, a solid electrolyte layer 40, and a positive electrode 50. As illustrated in FIG. 3, the all-solid-state secondary battery may have a bicell structure.

Each of the unit cells 10 may include the positive electrode 50 in the middle or central region (in a stacking direction), the solid electrolyte layers 40 on upper and lower sides of the positive electrode 50, and the negative electrode 30 on the solid electrolyte layer 40. The positive electrode 50 may include a positive electrode current collector 51 and positive electrode active material layers 52 on both surfaces of the positive electrode current collector 51. The negative electrode 30 may include a negative electrode current collector 31 and a negative electrode active material layer on one surface thereof.

In an implementation, each of the unit cells 10 may be formed by placing the positive electrode current collector 51 in the middle in the stacking direction, and sequentially stacking the positive electrode active material layer 52, the solid electrolyte layer 40, the negative electrode active material layer, and the negative electrode current collector 31 on each of both surfaces of the positive electrode current collector.

As shown in FIG. 3, the negative electrode 30 may be a precipitation-type negative electrode, and it may include a negative electrode coating layer 33 on the negative electrode current collector 31. The initial charging may begin in the absence of a negative electrode active material, and during the charging, lithium metal with a high density or the like may be precipitated between the negative electrode current collector 31 and the negative electrode coating layer 33 and may form a lithium metal layer 34, which can serve as a negative electrode active material layer.

Accordingly, in an all-solid-state battery that has been charged one or more times, the precipitation-type negative electrode 30 may include the negative electrode current collector 31, the lithium metal layer 34 on the negative electrode current collector 31, and the negative electrode coating layer 33 on the lithium metal layer 34. The lithium metal layer 34 refers to a layer of lithium metal or the like precipitated during the charging process of the battery and may be called a metal layer or a negative electrode active material layer.

The unit cells 10 may be stacked in a direction in which the negative electrode 30, the solid electrolyte layer 40, and the positive electrode 50 are stacked. At least two unit cells 10 may be arranged adjacent to each other.

The ceramic insulating layers 20 may be between the negative electrodes 30 of the unit cells 10 that are adjacent to each other and are stacked on the negative electrodes 30 on both outermost sides of (e.g., each of) the unit cells 10. In an implementation, the first cell 101 of the adjacent unit cells 10 may include the positive electrode active material layer 52, the solid electrolyte layer 40, the lithium metal layer 34 serving as a negative electrode active material layer, and the negative electrode current collector 31 sequentially stacked on each of both surfaces of the positive electrode current collector 51.

The second cell 102 (adjacent to the first cell 101) may include the positive electrode active material layer 52, the solid electrolyte layer 40, the lithium metal layer 34 serving as a negative electrode active material layer, and the negative electrode current collector 31 sequentially stacked on each of both surfaces of the positive electrode current collector 51. In an implementation, the ceramic insulating layers 20 between the first cell 101 and the second cell 102 among the ceramic insulating layers 20 may be a single layer between the pair of facing negative electrode current collectors 31.

The ceramic insulating layers 20 may be on sides of the negative electrodes 30 opposite to the solid electrolyte layers 40. If the all-solid-state secondary battery were to be damaged due to an external force, e.g., penetration or collision, the positive electrode 50 and the negative electrode 30 could be electrically short-circuited. In an implementation, the ceramic insulating layers 20 may protect the unit cells 10, as functional layers on the outermost sides of the unit cells 10, thereby reducing an amount of heat generation of the unit cells 10.

In an implementation, in an all-solid-state secondary battery formed by stacking a plurality of unit cells 10, the ceramic insulating layers 20 may be between the unit cells 10, thereby preventing the positive electrodes 50 and negative electrodes 30 of the unit cells 10 adjacent to each other from directly contacting each other beyond the respective unit cells 10. As a result, thermal runaway due to collapse of the positive electrode active material layer 52 and the lithium metal layer 34 serving as the negative electrode active material layer may be prevented.

The ceramic insulating layers 20 may help prevent a direct short circuit between the positive electrode 50 and the negative electrode 30, in the event that the cell is damaged due to an external impact, thereby reducing the amount of heat generation due to the short circuit. In an implementation, the ceramic insulating layer 20 may include ceramic particles and a binder. In an implementation, the ceramic particles may include, e.g., alumina or boehmite.

The ceramic particles in the ceramic insulating layer 20 may provide insulating properties to help prevent a short circuit between the positive electrode 50 and the negative electrode 30.

Below, results of Experimental Examples 1 to 4 and Comparative Example 1, which observed the effects of thickness, particle diameter, and a ratio of the binder to the ceramic particles forming the ceramic insulating layer 20 on a short-circuit resistance ratio indicating insulating properties accordingly, which are shown in Table 1.

TABLE 1

| | | | Particle | | | Short- |
|---|---|---|---|---|---|---|
| | | Thickness | diameter | | | circuit |
| | Ceramic | of ceramic | (D50) of | | | resis- |
| | insulating | insulating | ceramic | Binder | | tance |
| | layer | layer | particles | ratio | | ratio |
| Comparative | Not | — | — | — | | 1 |
| Example 1 | applied | | | | | |
| Experimental | applied | 10 μm | 2 μm | 5 | wt % | 123.58 |
| Example 1 | | | | | | |
| Experimental | applied | 10 μm | 3 μm | 5 | wt % | 133.77 |
| Example 2 | | | | | | |
| Experimental | applied | 20 μm | 2 μm | 5 | wt % | 658.65 |
| Example 3 | | | | | | |
| Experimental | applied | 10 μm | 2 μm | 10.0 | wt % | 137.3 |

Example 4

As seen in Experimental Examples 1 to 3, the short-circuit resistance ratio indicated that insulating properties were most affected by the thickness of the ceramic insulating layer 20. The thickness comparison of the ceramic insulating layer 20 may be observed by comparing Experimental Examples 1 and 3. The thickness of the ceramic insulating layer 20 may be between at least 5 μm and 50 μm.

Maintaining the thickness at 5 μm or greater may help ensure that a meaningful short-circuit resistance ratio is obtained, e.g., due to sufficient insulating properties. Maintaining the thickness at 50 μm or less may help ensure that the ceramic particles and binder are not used excessively compared to securing additional insulating properties.

The thickness in Experimental Examples 1 to 4 was 10 μm to 20 μm. The thickness within the range of 10 μm to 20 μm may enable an appropriate short-circuit resistance ratio to be obtained with appropriate amounts of ceramic particles and binder used. Compared to Comparative Example 1, in which the ceramic insulating layer was not applied, Experimental Examples 1 to 4 had a significantly greater short-circuit resistance ratio.

In an implementation, the ceramic insulating layer 20 may include 5 wt % to 10 wt % of the binder and 90 wt % to 95 wt % of the ceramic particles. The thickness comparison of the ceramic insulating layer 20 may be observed by comparing Experimental Examples 1 and 3. It may be seen that the thicker the ceramic insulating layer 20, the greater the short circuit resistance ratio.

Additionally, it may be seen from Experimental Examples 1 to 3 that the thicker the ceramic insulating layer 20, the greater the short circuit resistance ratio. The binder ratio did not have a significant effect on the experiment when it was 5 to 10 wt %.

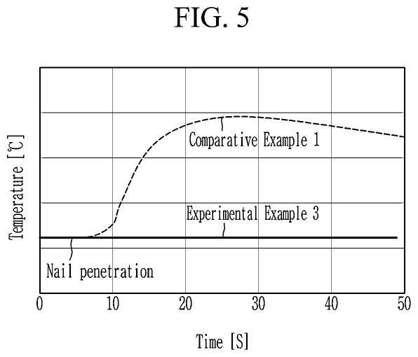

FIG. 5 is a graph showing a temperature relationship over time during nail penetration through an all-solid-state secondary battery. Referring to FIG. 5, Experimental Example 3, in which the ceramic insulating layer 20 was applied, showed excellent penetration characteristics while showing that the temperature did not increase during the nail penetration, compared to Comparative Example 1, in which the ceramic insulating layer was not applied. The penetration evaluation conditions with respect to temperature were at room temperature, a diameter of a nail pin of 3 mm, and a penetration speed of the nail of 50 mm/sec.

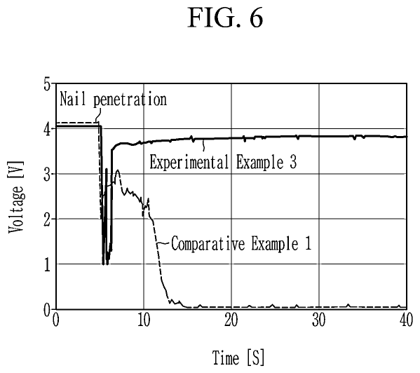

FIG. 6 is a graph showing a voltage relationship over time during nail penetration through an all-solid-state secondary battery. Referring to FIG. 6, Experimental Example 3, in which the ceramic insulating layer 20 was applied, recovered and maintained a slightly lower voltage level than before nail penetration when the nail penetrated, and showed excellent penetration characteristics, compared to Comparative Example 1, in which the ceramic insulating layer was not applied. The penetration evaluation conditions with respect to voltage were at a room temperature, a diameter of a nail pin of 3 mm, and a penetration speed of the nail of 50 mm/sec.

In this way, the ceramic insulating layer 20 may be applied, and the short circuit resistance ratio may increase, which means that safety may also increase. In an implementation, as the short-circuit resistance ratio increases, the penetration performance and collision performance may improve.

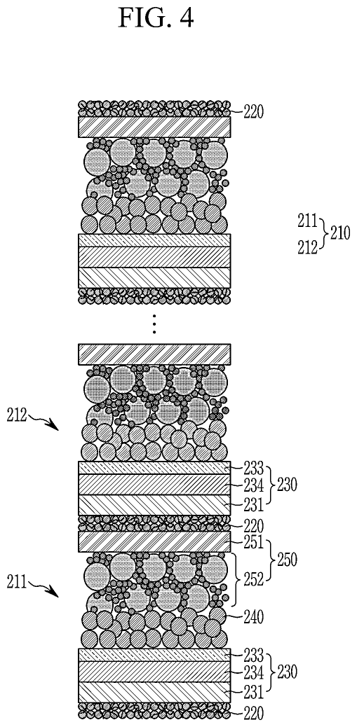

FIG. 4 is a longitudinal cross-sectional view showing an all-solid-state secondary battery according to a second embodiment. Referring to FIG. 4, each of the unit cells 210 may include a solid electrolyte layer 240 on one side of a positive electrode 250, and a negative electrode 230 on the solid electrolyte layer 240. The positive electrode 250 may include a positive electrode current collector 251 and a positive electrode active material layer 252 on one surface of the positive electrode current collector 251. The negative electrode 230 may include a negative electrode current collector 231 and a lithium metal layer 234 on one surface of the negative electrode current collector 231 and serving as a negative electrode active material layer.

In an implementation, each of the unit cells 210 may be formed by sequentially stacking, on one surface of the positive electrode current collector 251, the positive electrode active material layer 252, the solid electrolyte layer 240, a negative electrode coating layer 233, the lithium metal layer 234 serving as a negative electrode active material layer and formed by precipitation of lithium metal during charging, and the negative electrode current collector 231.

The unit cells 210 may be stacked in a direction in which the negative electrode 230, the solid electrolyte layer 240, and the positive electrode 250 are stacked. At least two unit cells 210 may be arranged adjacent to each other.

The ceramic insulating layers 220 may be between the positive electrode 250 and the negative electrode 230 of the unit cells 210 that are adjacent to each other and are stacked on the negative electrodes 230 positioned on both outermost sides of the unit cells 210. In an implementation, the first cell 211 of the adjacent unit cells 210 may include the positive electrode active material layer 252, the solid electrolyte layer 240, the negative electrode coating layer 233, the lithium metal layer 234 serving as a negative electrode active material layer, and the negative electrode current collector 231 sequentially stacked on one surface of the positive electrode current collector 251.

The second cell 212 adjacent to the first cell 211 may include the positive electrode active material layer 252, the solid electrolyte layer 240, the negative electrode coating layer 233, the lithium metal layer 234 serving as a negative electrode active material layer, and the negative electrode current collector 231 sequentially stacked on one surface of the positive electrode current collector 251. In an implementation, the ceramic insulating layer 220 between the positive electrode current collector 251 of the first cell 211 and the negative electrode current collector 231 of the second cell 212 among the ceramic insulating layers 220 may be a single layer.

The ceramic insulating layers 220 may be on a side of the outermost negative electrode 230 opposite to the solid electrolyte layer 240 and on a side of the positive electrode 250 opposite to the solid electrolyte layer 240. If the all-solid-state secondary battery were to be damaged due to an external force, e.g., penetration or collision, the positive electrode 250 and the negative electrode 230 could be electrically short-circuited. In an implementation, the ceramic insulating layers 220 may help protect the unit cells 210 as a functional layer on the outermost sides of the unit cells 210, thereby reducing an amount of heat generation of the unit cells 210.

In an implementation, in an all-solid-state secondary battery formed by stacking a plurality of unit cells 210, the ceramic insulating layers 220 may be between the unit cells 210, preventing the positive electrodes 250 and negative electrodes 230 of the cells 210 adjacent to each other from directly contacting each other beyond the respective unit cells 210. As a result, thermal runaway due to collapse of the positive electrode active material layer 252 and the lithium metal layer 234 serving as the negative electrode active material layer may be prevented.

In an implementation, heat may be generated in the unit cells 210, and the ceramic insulating layers 220 may facilitate heat dissipation and thus may help effectively lower the temperature of the unit cells 210. In an implementation, the ceramic insulating layer 220 may include ceramic particles and a binder. In an implementation, the ceramic particles may include alumina or boehmite.

The ceramic particles in the ceramic insulating layer 220 may provide insulating properties to help prevent a short circuit between the positive electrode 250 and the negative electrode 230. The ceramic insulating layers 220 may help prevent a direct short circuit between the positive electrode 250 and the negative electrode 230 if the cell were to be damaged due to an external impact, thereby reducing the amount of heat generation due to the short circuit.

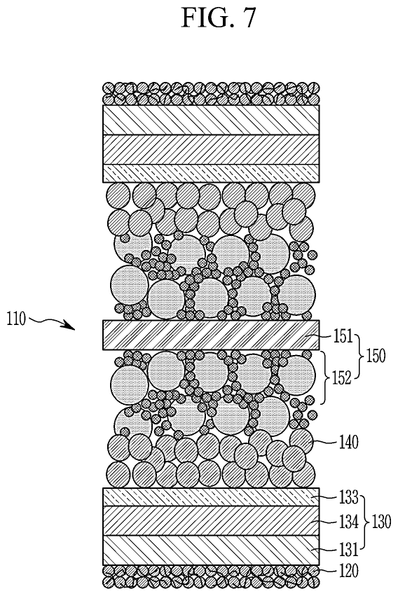

FIG. 7 is a longitudinal cross-sectional view showing an all-solid-state secondary battery according to a third embodiment. Referring to FIG. 7, an all-solid-state secondary battery of an embodiment may include a laminate 110 and ceramic insulating layers 120. The laminate 110 may include a stack of a negative electrode 130, a solid electrolyte layer 140, and a positive electrode 150. As illustrated in FIG. 7, the all-solid-state secondary battery may have a bicell structure.

The laminate 110 may include the positive electrode 150 in the middle in a stacking direction, the solid electrolyte layers 140 on upper and lower sides of the positive electrode 150, and the negative electrode 130 on the solid electrolyte layer 140. The positive electrode 150 may include a positive electrode current collector 151 and positive electrode active material layers 152 on both surfaces of the positive electrode current collector 51. The negative electrode 130 may include a negative electrode current collector 131 and a negative electrode active material layer on one surface thereof.

In an implementation, the laminate 110 may be formed by placing the positive electrode current collector 151 in the middle in the stacking direction, and sequentially stacking the positive electrode active material layer 152, the solid electrolyte layer 140, the negative electrode active material layer, and the negative electrode current collector 131 on each of both surfaces of the positive electrode current collector.

As shown in FIG. 7, the negative electrode 130 may be a precipitation-type negative electrode, and it may include a negative electrode coating layer 133 on the negative electrode current collector 131. The initial charging may begin in the absence of a negative electrode active material, and during the charging, lithium metal with a high density or the like may be precipitated between the negative electrode current collector 131 and the negative electrode coating layer 133 and may form a lithium metal layer 134, which may serve as a negative electrode active material layer.

In an implementation, in an all-solid-state battery that has been charged one or more times, the precipitation-type negative electrode 130 may include the negative electrode current collector 131, the lithium metal layer 134 positioned on the negative electrode current collector 131, and the negative electrode coating layer 133 positioned on the lithium metal layer 134. The lithium metal layer 134 refers to a layer of lithium metal or the like precipitated during the charging process of the battery and may be called a metal layer or a negative electrode active material layer.

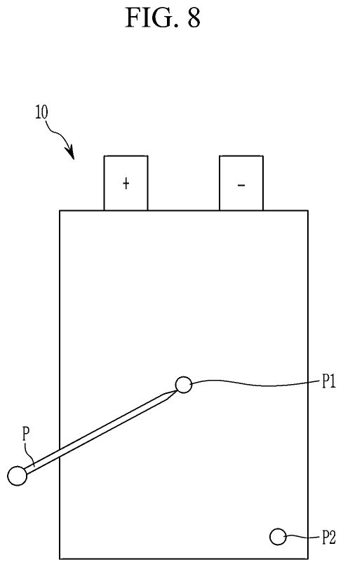

The ceramic insulating layers 120 may be stacked on both outermost sides of the laminate 110. The ceramic insulating layers 120 may be on sides of the negative electrodes 130 opposite to the solid electrolyte layers 140. If the all-solid-state secondary battery were to be damaged by an external force, e.g., penetration by a penetration pin (P) (see FIG. 8) or collision, the positive electrode 150 and the negative electrode 130 could be electrically short-circuited. In an implementation, the ceramic insulating layers 120 may help protect the laminate 110, as functional layers on the outermost sides of the laminate 110, thereby reducing an amount of heat generation of the laminate 110.

In an implementation, heat may be generated in the laminate 110, and the ceramic insulating layers 120 may facilitate heat dissipation and thus may help effectively lower the temperature of the laminate 110. In an implementation, the ceramic insulating layers 120 may include a conductive material, a ceramic material, and a binder. In an implementation, the ceramic material may include alumina or boehmite.

In the ceramic insulating layers 120, the ceramic material may provide insulating properties to help prevent a short circuit between the positive electrode 150 and the negative electrode 130, and the conductive material may provide thermal conductivity to assist heat dissipation and thus prevent thermal runaway. In an implementation, the ceramic insulating layers 120 may help protect the negative electrode current collector 131 from gas generated inside the laminate 110, and may minimize pores and gas penetration due to rolling.

Below, results of Experimental Examples 11 to 14 and Comparative Example 2, which measured the insulating properties, thermal conductivity, and heat dissipation according to the composition ratio of the conductive material and the ceramic material forming the ceramic insulating layers 120, and are shown in Table 2. The penetration experiment was conducted at room temperature, the diameter of the penetration pin (P) was 3 mm, and the penetration speed of the penetration pin (P) was 50 mm/sec.

During the penetration evaluation, there were some differences for each cell of the all-solid-state battery, but the maximum temperature was reached within 20 seconds immediately after penetration through the all-solid-state battery. The maximum temperature difference appeared when the maximum temperature was reached, in Experimental Examples 11 to 14 and Comparative Example 2, the temperature was measured within 30 seconds immediately after penetration through the all-solid-state battery, and resultantly, the temperature difference ratio between the central and peripheral portions and the maximum temperature ratio at the central portion were obtained.

TABLE 2

| | | Thickness of | | | Temperature | |
|---|---|---|---|---|---|---|
| | Ceramic | ceramic | Conductive | | difference ratio | Maximum |
| | insulating | insulating | material | Binder | between central and | temperature ratio |
| | layer | layer | ratio | ratio | peripheral portions | in central portion |
| Comparative | Not applied | — | — | — | 100% | 100% |
| Example 2 | | | | | | |
| Experimental | applied | 5 μm | — | 5 wt % | 39% | 35% |
| Example 11 | | | | | | |
| Experimental | applied | 5 μm | 5 wt % | 5 wt % | 11% | 16% |
| Example 12 | | | | | | |
| Experimental | applied | 5 μm | 5 wt % | 10 wt % | 12% | 16% |
| Example 13 | | | | | | |
| Experimental | applied | 5 μm | 10 wt % | 5 wt % | 9% | 15% |
| Example 14 | | | | | | |

As shown in Comparative Example 2 and Experimental Examples 11 to 14, in the laminate 110 of Comparative Example 2, in which the ceramic insulating layer 120 was not applied, and the laminates 110 of Experimental Examples 11 to 14, in which the ceramic insulating layer 120 was applied, it may be seen that the ceramic insulating layer 120 had a significant effect on the thermal conductivity and heat dissipation. The ceramic insulating layer 120 had a great effect on the temperature difference ratio between the central portion (P1) and the peripheral portion (P2) and the maximum temperature ratio at the central portion, which indicated the thermal conductivity and heat dissipation.

In addition, as shown in Experimental Examples 11 to 14, in the laminate 110 of Experimental Example 11, in which the conductive material was not applied, and the laminates 110 of Experimental Examples 12 to 14, in which the conductive material was applied, it may be seen that the conductive material had a significant effect on the thermal conductivity and heat dissipation. That is, the conductive material had the greatest effect on the temperature difference ratio between the central portion (P1) and the peripheral portion (P2) and the maximum temperature ratio at the central portion, which indicated the thermal conductivity and heat dissipation.

Comparison of the ratio of the conductive material in the ceramic insulating layer 120 may be observed by comparing Experimental Example 12 and Experimental Example 14. In an implementation, the conductive material in the ceramic insulating layer 120 may be included in an amount between 0.1 wt % and 30 wt %.

Maintaining the ceramic content at 30 wt % or greater may help prevent a deterioration in the electrical insulation performance of the ceramic insulating layer 120, which could otherwise occur due to a lack of ceramic. Maintaining the ceramic content at 95 wt % or less may help ensure that the content of the conductive material in the ceramic insulating layer 120 is sufficient, thereby preventing a deterioration of the heat dissipation and heat conduction performance.

Maintaining the content of the conductive material at 0.1 wt % or greater may help ensure that the content of the conductive material is sufficient, so that the ceramic insulating layer 120 may provide sufficient heat dissipation and heat conduction performance. Maintaining the content of the conductive material at 30 wt % or less may help prevent a deterioration in the battery insulation performance of the ceramic insulating layer 120, which could otherwise occur due to an excessive amount of the conductive material.

Maintaining the binder content at 1 wt % or greater may help prevent a deterioration in the binding performance of the ceramic particles and the conductive material particles in the ceramic insulating layer 120, which could otherwise occur due to a lack of binder. Maintaining the binder content at 40 wt % or less may help prevent a deterioration in the heat dissipation and heat conduction performance of the conductive material in the ceramic insulating layer 120, which could otherwise occur due to an excess of binder.

In Experimental Example 12, the ceramic insulating layer included 90 wt % of ceramic, 5 wt % of conductive material, and 5 wt % of binder. In Experimental Example 13, the ceramic insulating layer included 85 wt % of ceramic, 5 wt % of conductive material, and 10 wt % of binder. In Experimental Example 14, the ceramic insulating layer included 85 wt % of ceramic, 10 wt % of conductive material, and 5 wt % of binder. That is, referring to Experimental Examples 12 to 14, the ceramic insulating layer may include 80 to 90 wt % of ceramic, 5 to 10 wt % of conductive material, and 5 to 10 wt % of binder.

FIG. 8 is a plan view showing a position of a laminate where a penetration pin penetrated during a penetration test in Experimental Examples 11 to 14 and Comparative Example 2. Referring to FIG. 8, during the penetration test of the penetration pin (P), a temperature measurement portion of the laminate included a central portion (P1) where the penetration pin (P) was inserted and a peripheral portion (P2) at least 30 mm away from the penetration pin (P). The difference in heat dissipation characteristics, e.g., heat conduction characteristics, may be compared by the temperature difference between the central portion (P1) and the peripheral portion (P2).

As shown in Table 2, the difference in heat conduction characteristics may be indicated by the temperature difference ratio between the central portion (P1) and the peripheral portion (P2) and the maximum temperature ratio at the central portion. In Comparative Example 2, the temperature difference ratio between the central portion (P1) and the peripheral portion (P2) was a reference value of 100%, and the maximum temperature ratio at the central portion was a reference value of 100%. In Experimental Example 11, the temperature difference ratio between the central portion (P1) and the peripheral portion (P2) was 39%, and the maximum temperature ratio at the central portion was 35%.

In Comparative Example 2, there was no ceramic insulating layer, the temperature of the central portion (P1) was very high, and the temperature difference ratio between the central portion (P1) and the peripheral portion (P2) was very large because the heat dissipation characteristics, e.g., the heat conduction characteristics, were low.

In Experimental Example 11, the ceramic insulating layer (without a conductive material) was applied, so the ceramic insulating layer partially prevented an electrical short circuit and lowered the amount of heat generation. Therefore, the maximum temperature of the central portion (P1) was lowered to about 35%, compared to the maximum temperature of the central portion (P1) of the Comparative Example 2.

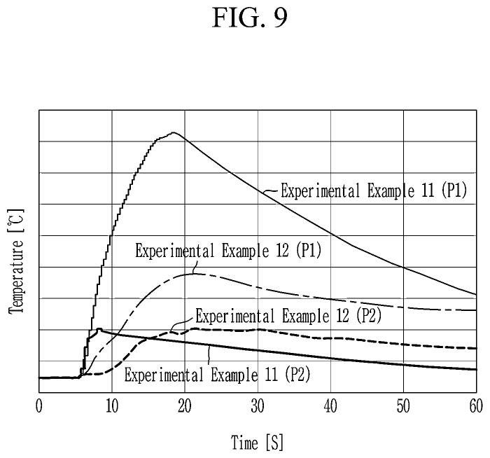

FIG. 9 is a graph showing temperature changes over time at a central portion where the penetration pin penetrates and a peripheral portion in Experimental Examples 11 and 12 during a test of FIG. 7. Referring to FIG. 9, the penetration pin (P) penetrated and there was no conductive material in the ceramic insulating layer, it was difficult for heat generated to be dissipated to the outside, and it was also difficult for heat to be transferred in the horizontal direction, e.g., in a direction from the central portion (P1) toward the peripheral portion (P2). Therefore, the heat generated locally at the central portion (P1) was present at the central portion (P1), so that a relatively high temperature state was exhibited compared to Experimental Examples 12 to 14. Experimental Example 11 had relatively lower heat dissipation and heat transfer performance compared to Experimental Examples 12 to 14.

In Experimental Example 12, the conductive material was applied to the ceramic insulating layer 120, so the heat generated along with the penetration of the penetration pin (P) was dissipated outward through the conductive material, and accordingly, the maximum temperature of the central portion (P1) was relatively lower compared to Experimental Example 11. That is, in Experimental Example 12, it may be seen that the slope of the temperature rise gradually increased due to the heat dissipation and the heat transfer in the horizontal direction.

In Experimental Example 11, the penetration of the penetration pin (P) resulted in a large temperature difference between the central portion (P1) and the peripheral portion (P2). In Experimental Example 12, the penetration of the penetration pin (P) resulted in a small temperature difference between the central portion (P1) and the peripheral portion (P2). Therefore, the effect of the conductive material in the ceramic insulating layer 120 may be confirmed.

By way of summation and review, some lithium-ion batteries may use electrolyte solutions containing flammable organic solvents, so there is a possibility of overheating and fire in the event of a short circuit. Accordingly, an all-solid-state secondary battery using a solid electrolyte instead of an electrolyte solution has been considered.

By not using flammable organic solvents, all-solid-state secondary batteries may help greatly reduce the possibility of fire or explosion even in the event of a short circuit. Therefore, the all-solid-state batteries may help greatly increase safety compared to lithium-ion batteries using electrolyte solutions.

One or more embodiments may provide an all-solid-state secondary battery that prevents damage due to external impacts. One or more embodiments may provide an all-solid-state secondary battery in which a ceramic insulating layer prevents a direct short circuit between a positive electrode and a negative electrode when a cell is damaged due to an external impact, thereby reducing an amount of heat generation due to the short circuit.

One or more embodiments may provide an all-solid-state secondary battery that assists heat dissipation to effectively lower the temperature when heat is generated.

In an embodiment, the ceramic insulating layers containing a ceramic material may be between the plurality of unit cells and on the outermost sides, so it is possible to prevent damage due to an external impact and to prevent an electrical short circuit between the negative electrode and the positive electrode by the ceramic material in the event of damage.

In an embodiment, the ceramic insulating layer may help prevent a direct short circuit between the positive electrode and the negative electrode if a cell were to be damaged due to an external impact, thereby reducing an amount of heat generation due to the short circuit.

In an embodiment, the ceramic insulating layer may help prevent damage to the negative electrode current collector and damage to all the negative electrode current collectors in each unit cell in the event of damage due to an external impact.

In an embodiment, the ceramic insulating layer may help protect the negative electrode current collector from gases generated inside the plurality of unit cells, and may help minimize pores and gas penetration due to rolling.

In an embodiment, the ceramic insulating layers including a conductive material and a ceramic material may be on the outermost sides of the laminate, so it is possible to help prevent damage due to an external impact, prevent an electrical short circuit between the negative electrode and the positive electrode by the ceramic material in the event of damage, and assist heat dissipation by the conductive material to effectively lower the temperature when heat is generated.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

<Description of symbols>

10, 210: unit cell
20, 220: ceramic insulating layer
30, 230: negative electrode
31, 231: negative electrode current collector
33, 233: negative electrode coating layer
34, 234: lithium metal layer
40, 240: solid electrolyte layer
50, 250: positive electrode
51, 251: positive electrode current collector
52, 252: positive electrode active material layer
110: laminate
120: ceramic insulating layer
130: negative electrode
131: negative electrode current collector
133: negative electrode coating layer
134: lithium metal layer
140: solid electrolyte layer
150: positive electrode
151: positive electrode current collector
152: positive electrode active material layer
P: penetration pin
P1: central portion
P2: peripheral portion

What is claimed is:

1. An all-solid-state secondary battery, comprising:
a plurality of unit cells each comprising a stack of a negative electrode, a solid electrolyte layer, and a positive electrode; and
a plurality of ceramic insulating layers, the plurality of ceramic insulating layers being:
between the negative electrodes of adjacent unit cells of the plurality of unit cells, and
on the negative electrodes at outermost sides of the plurality of unit cells.

2. The all-solid-state secondary battery as claimed in claim 1, wherein each unit cell of the plurality of unit cells comprises:
a positive electrode current collector of the positive electrode in a middle, and
a stack of a positive electrode active material layer of the positive electrode, the solid electrolyte layer, a negative electrode active material layer of the negative electrode, and a negative electrode current collector of the negative electrode sequentially on each of opposite surfaces of the positive electrode current collector.

3. The all-solid-state secondary battery as claimed in claim 2, wherein the plurality of ceramic insulating layers are on outer surfaces of each negative electrode current collector.

4. The all-solid-state secondary battery as claimed in claim 2, wherein:
a first unit cell of the adjacent unit cells of the plurality of unit cells comprises:
the positive electrode active material layer,
the solid electrolyte layer,
the negative electrode active material layer, and
the negative electrode current collector sequentially stacked on each of opposite surfaces of the positive electrode current collector,
a second unit cell of the adjacent unit cells of the plurality of unit cells is adjacent to the first unit cell comprises:
the positive electrode active material layer,
the solid electrolyte layer,
the negative electrode active material layer, and
the negative electrode current collector sequentially stacked on each of opposite surfaces of the positive electrode current collector, and
ceramic insulating layers of the plurality of ceramic insulating layers are between the first unit cell and the second unit cell and are in a single layer between a pair of the negative electrode current collectors.

5. The all-solid-state secondary battery as claimed in claim 1, wherein the plurality of ceramic insulating layers each comprise:
alumina or boehmite, and
a binder.

6. The all-solid-state secondary battery as claimed in claim 1, wherein the plurality of ceramic insulating layers each comprise 5 to 10 wt % of a binder and 90 to 95 wt % of ceramic particles, based on a total weight of the ceramic insulating layer.

7. The all-solid-state secondary battery as claimed in claim 1, wherein a thickness of each ceramic insulating layer of the plurality of ceramic insulating layers is 5 μm to 50 μm.

8. The all-solid-state secondary battery as claimed in claim 1, wherein each unit cell of the plurality of unit cells comprises:
a positive electrode active material layer,
the solid electrolyte layer,
a negative electrode active material layer forming the negative electrode, and
a negative electrode current collector sequentially stacked on one surface of a positive electrode current collector forming the positive electrode.

9. The all-solid-state secondary battery as claimed in claim 8, wherein:
a first unit cell of the adjacent unit cells of the plurality of unit cells comprises:
the positive electrode active material layer,
the solid electrolyte layer, the negative electrode active material layer, and
the negative electrode current collector sequentially stacked on one surface of the positive electrode current collector,
a second unit cell of the adjacent unit cells of the plurality of unit cells is adjacent to the first unit cell comprises:
the positive electrode active material layer,
the solid electrolyte layer, the negative electrode active material layer, and
the negative electrode current collector sequentially stacked on one surface of the positive electrode current collector, and
ceramic insulating layers of the plurality of ceramic insulating layers are between the positive electrode current collector of the first unit cell and the negative electrode current collector of the second unit cell are in a single layer.

10. An all-solid-state secondary battery, comprising:
a laminate comprising a stack of a negative electrode, a solid electrolyte layer, and a positive electrode; and
a ceramic insulating layer on a side of the negative electrode that is opposite to the solid electrolyte layer and at an outermost side of the laminate, the ceramic insulating layer comprising a conductive material.

11. The all-solid-state secondary battery as claimed in claim 10, wherein the laminate comprises:
a positive electrode current collector of the positive electrode in a middle, and
a stack of a positive electrode active material layer of the positive electrode, the solid electrolyte layer, a negative electrode active material of the negative electrode, and a negative electrode current collector of the negative electrode sequentially on each of opposite surfaces of the positive electrode current collector.

12. The all-solid-state secondary battery as claimed in claim 10, wherein the ceramic insulating layer comprises 30 to 95 wt % of a ceramic material, 0.1 to 30 wt % of a conductive material, and 1 to 40 wt % of a binder, based on a total weight of the ceramic insulating layer.

13. The all-solid-state secondary battery as claimed in claim 10, wherein the ceramic insulating layer comprises 80 to 90 wt % of a ceramic material, 5 to 10 wt % of a conductive material, and 5 to 10 wt % of a binder, based on a total weight of the ceramic insulating layer.

14. The all-solid-state secondary battery as claimed in claim 10, wherein:
a temperature measurement portion of the laminate during a penetration test of a penetration pin comprises:
a central portion where the penetration pin is inserted, and
a peripheral portion at least 30 mm away from the penetration pin, and
a temperature difference ratio between the central portion and the peripheral portion is 9 to 39% if heat dissipation characteristics are compared based on a temperature difference ratio between the central portion and the peripheral portion.

15. The all-solid-state secondary battery as claimed in claim 14, wherein the temperature difference ratio between the central portion and the peripheral portion is 9 to 12%.

16. The all-solid-state secondary battery as claimed in claim 14, wherein a maximum temperature ratio at the central portion is 15 to 35%, compared with an all-solid-state secondary battery that does not include the ceramic insulating layer.

17. The all-solid-state secondary battery as claimed in claim 14, wherein a maximum temperature ratio at the central portion is 15 to 16%, compared with an all-solid-state secondary battery that does not include the ceramic insulating layer.
